(19) United States
(12) Patent Application Publication
(10) Pub. No.: US 2014/0020828 A1
(43) Pub. Date: Jan. 23, 2014

(54) Fast Curing CPVC Solvent Cement

(71) Applicant: OATEY COMPANY, Cleveland, OH (US)

(72) Inventors: Amrit Kaur Parhar, Westlake, OH (US); Forest Hampton, III, Amherst, OH (US)

(21) Appl. No.: 13/803,343

(22) Filed: Mar. 14, 2013

Related U.S. Application Data
(60) Provisional application No. 61/672,970, filed on Jul. 18, 2012.

(51) Int. Cl. C09J 127/24

(52) U.S. Cl. CPC C09J 127/24
USPC 156/333; 524/113

(57) ABSTRACT

A composition and method of using the composition are described. The composition is useful for quickly bonding chlorinated polyvinylchloride during installation and repair operations. Embodiments of the composition include at least one volatile organic solvent, chlorinated polyvinylchloride dissolved in the solvent and the composition is substantially free of cyclohexanone.

### CROSS-REFERENCE TO RELATED APPLICATIONS

This non-provisional patent application claims the benefit of U.S. Provisional Application No. 61/672,970, filed Jul. 18, 2012, the content of which is hereby incorporated by reference as if fully recited herein.

### TECHNICAL FIELD

The present invention is in the field of adhesives and more particularly in the field of solvent cements useful for plumbing applications including drain, waste, vent and pressurized applications.

### BACKGROUND

Many plumbing applications such as drain, waste, vent and pressure pipe applications utilize thermoplastic resin-based plastics due to their ease of manufacture, cost and water and corrosion resistance. However, these plastics often require upgrading or need repair after extended use. When repairs, new installations or upgrades are required, the piping is necessarily taken out of service. While outages for repair or upgrade are unavoidable, the length of these outages can create significant problems for municipalities or businesses with significant plumbing needs such as hotels and hospitals. No matter the underlying cost, when repairs or upgrades are performed, the joints between sections of piping must be secured together.

Joints for plastic plumbing and other articles made from molded plastics such as polyvinyl chloride (PVC) or chlorinated polyvinyl chloride (CPVC) are often secured by solvent cements. These solvent cements are conventionally made from a combination of solvents, and resins dissolved in the mixture.

Solvent cementing is a process in which thermoplastics, usually amorphous, are softened by the application of a suitable solvent or mixture of solvents, and then pressed together to effect a bond. Many thermoplastic substrates are easier to join effectively by solvent cements than by conventional adhesive bonding. Generally, a small amount of the same resin that makes up the substrate is dissolved in a solvent to form the cement. The inclusion of the resin aids in gap filling, accelerates setting, and reduces shrinkage and internal stresses.

For many years, solvent cements have been made for joining CPVC plastic pipe and fittings. The major uses are drain, waste, vent. sewer and potable water conveyance. Plastic pipe has increasingly displaced the traditional materials used for the same purpose such as copper, steel, galvanized metal, cast iron, lead and concrete asbestos pipe. Plastic pipe has become the material of choice in the home, municipal, and manufacturing industries.

ASTM F-493 sets forth the requirements for CPVC solvent cements as containing a minimum of 10% CPVC resin, inert fillers, and the remainder is one or more solvents including THF, CYH, MEK and/or acetone.

Pipes and fittings of CPVC are used for applications where, in addition to high internal pressures of up to 5 bar, temperatures in the range from ambient to at least about 95° C. are encountered. Solvent cements for pipes and fittings of CPVC contain between 10 and 30% by weight CPVC in combination with suitable solvents, such as tetrahydrofuran, cyclohexanone, methyl ethyl ketone, N-methylpyrrolidone, methylene chloride, acetone, ethyl acetate and the like. The adhesives may contain consistency-generating constituents such as thickeners, thixotropic agents and the like.

Conventionally, cyclohexanone has been used in every marketed CPVC solvent cement. This is due to the perception that cyclohexanone provides benefits that other common solvents do not. Specifically, stronger joints, and extended working time for artisans working with the joint, allowing for a more optimal fit between the pipes making up the joint. It is thought that the higher boiling point of cyclohexanone allows it to penetrate the plastic of the pipe more thoroughly, allowing the plumber more time to make the proper fit and alignment between pipes, and correspondingly, the cyclohexanone's greater penetration was thought to more thoroughly soften the plastic prior to curing, creating a stronger bond between the pipes once the joint is cured.

### SUMMARY

This and other unmet needs of the prior art are met by compounds and methods as described in more detail below.

The disclosed embodiments describe a solvent cement for securing chlorinated polymers. The cement includes at least one solvent selected from the list consisting of tetrahydrofuan, acetone, methyl-ethyl ketone; a thermoplastic resin; and wherein the cement has a very little cyclohexanone.

Provided herein is a solvent cement for bonding CPVC pipe and other molded articles, including at least one solvent selected from the group consisting of THF, ACE methylethyl ketone in an amount of between 0 and 80% by weight; a second solvent selected from the group consisting of THF, MEK and ACE in an amount from 0 to 10% by weight; at least one chlorinated thermoplastic resin in an amount of between 12 and 22% by weight, dissolved in the solvent; and substantially no cyclohexanone.

Disclosed embodiments include a method for bonding two CPVC articles. The method includes applying a solvent cement composition to a surface to be bonded on a first CPVC article, the composition comprising a first volatile organic solvent in an amount from 0 to 80% by weight, a second volatile organic solvent in an amount from 0 to 10% by weight, CPVC in an amount from 12-22%, and wherein the composition is substantially free of cyclohexanone; and bringing the surface to be bonded into contact with a second CPVC article.

Disclosed embodiments describe a method for securing two segments of chlorinated polymer articles together. The method includes applying an effective amount of a solvent cement to a surface to be bonded on a first chlorinated polymer article; contacting the first article with a second chlorinated polymeric article, forming a joint; and applying an effective amount of force to the joint for a cure time.

### DETAILED DESCRIPTION

In addition to the definitions contained in the Background, the following terms utilized in the present application and claims have the following meanings:

“solvent”—a substance capable of dissolving another substance;

“volatile solvent”—a solvent which evaporates rapidly at room temperature or at a slightly elevated temperature;

“solvent welding”—a process that utilizes solvents to join two surfaces together;

“solvent cement”—an adhesive made by dissolving a plastic resin or compound in a suitable solvent or mixture of solvents. The solvent cement dissolves the surfaces of the pipe and fittings to form a bond between the mating surfaces provided the proper cement is used for the particular materials and proper techniques are followed;

“cured”—when most of the solvent applied has evaporated leaving a thermoplastic solvent welded joint fused together so that pressure can be successfully applied;

“DWVP”—drain, waste, vent, and pressurized applications.

Disclosed embodiments provide a composition useful as a solvent cement that can be used to install or repair plastic pipe and fitting joints, the curing times for which is lower than for conventional solvent cements. It is intended to be understood that when discussing the compositions disclosed herein that the discussion should be equally applied to compositions useful in the methods disclosed herein.

Generally, a primer and solvent cement is used to make PVC or CPVC pipe and fitting joints. In plumbing applications, a wide variety of these primers and solvent cements are available. The primers are mixtures of various solvent combinations and solvent cements are mixtures of various solvents—Tetrahydrofuran, Methyl Ethyl Ketone, Cyclohexanone and Acetone—along with a specific resin dissolved in these solvents.

However, if a section of the plastic pipe has to be repaired for some reason, the available solvent cements take a long time to cure to full joint strength and the water supply has to be turned off for long periods of time, which is undesirable; especially in hospitals, hotels and apartment buildings. Examples of solvent cements and methods of use, contemplated by the instant disclosure may be found in U.S. Pat. No. 6,887,926, the content of which is hereby incorporated by reference as if fully recited herein.

The use of cyclohexanone in plastic pipe solvent cements is an industry mainstay. All marketed CPVC solvent cements include CYH. Its conventional acceptance is due to the amount of time allowed the skilled artisan to fit the pipe sections together as well as the generally high joint strengths made by CYH-containing cements.

The lower vapor pressure of cyclohexanone relative to other solvent cement solvents is a major contributor to its conventional acceptance. The lowered vapor pressure generally allows CYH-containing cements to linger on the surface of the pipe for longer and to penetrate further into the plastic, softening the putative joint material further and creating a deeper, stronger joint. Further, the lowered boiling point allows the plumber more time to make an optimal fit between pipe sections as the CYH-containing solvent cement does not dry-out quickly. Conventional thought is that fast cure times lead to stiff and unadaptable joints.

However, CYH-containing solvent cements require longer cure times for the joint to reach full strength. These longer cure times necessitate longer outages for businesses. It was thought that the longer cure times were “a necessary evil” that was unavoidable in order to achieve the high joint strength associated with CYH-containing solvent cements. Provided herein are methods and compositions that deliver high CPVC joint strength without the long cure times (and corresponding long outages) associated with conventional CYH-containing CPVC solvent cements.

Provided herein are solvent cements that overcome drawbacks of conventional solvent cements and are useful for CPVC pipe installation and repair. The main components are tetrahydrofuran (THF) and acetone (ACE) and cyclohexanone is completely avoided to shorten the joint cure time due to its high boiling point. Furthermore, disclosed embodiments include solvent cements including CPVC from about 5 to about 25% of the total weight of the solvent cement, from about 10 to about 20% and in certain embodiments about 18% CPVC.

Provided herein is a solvent cement for bonding CPVC pipe and other molded articles, including at least one solvent selected from the group consisting of THF, ACE methylethyl ketone at least one chlorinated thermoplastic resin dissolved in the solvent; and substantially no cyclohexanone.

Disclosed embodiments include a method for bonding two CPVC articles. The method includes applying a solvent cement composition to a surface to be bonded on a first CPVC article, the composition comprising a first volatile organic solvent in an amount from 0 to 80% by weight, a second volatile organic solvent in an amount from 0 to 10% by weight, CPVC in an amount from 12-22%, and wherein the composition is substantially free of cyclohexanone; and bringing the surface to be bonded into contact with a second CPVC article.

The chlorinated polyvinyl chlorides useful in the compositions of this invention include chlorinated polyvinyl chloride (also referred to sometimes as post-chlorinated PVC) homopolymers and copolymers. CPVC resins useful in this invention may be prepared by chlorination of any of the polyvinyl chloride homopolymers or copolymers discussed above by procedures known to those skilled in the art. CPVC resins available commercially, are generally available as powders, and may contain from about 57% to about 75% by weight of chlorine. CPVC is often the resin of choice where its high heat deflection resistance is desirable such as in hot water piping systems. CPVC resins useful as the water-insoluble resin in the composition of the invention are available commercially from, for example, Lubrizol under the trade designation Temprite 674×571. Chlorinated polyvinyl chlorides are available commercially from Lubrizol under the trade names Blazemaster®, Flowguard Gold® and Corzan®. Chlorinated polyvinyl chlorides are available from ATOFINA under the tradename Lucalor®.

In certain embodiments, the other polymers may be present in combination with the chlorinated polyvinyl chloride. In such embodiments, the chlorinated polyvinyl chloride is present in a major amount, or in amounts greater than 70%, or in amounts greater than 80%, or in amounts greater than 90% by weight of the polymers present in the solvent cements.

When the compositions are to be used as a solvent cement, the polymer or polymer mixture dissolved in the solvent to form the cement of the invention may be freshly prepared polymer, and in some instances may be polymer regrind.

Generally, the polymer or polymers in a cement are identical or at least chemically similar to the polymer surface(s) to be cemented. The compositions of the present invention generally will contain at least about 1%, or at least about 10%, or at least about 14%, or at least about 15%, or at least about 16%, or at least about 17%, or at least about 18%, or at least about 19%, or at least about 20%, or at least about 25% up to about 40% CPVC. More often, the composition contains CPVC from about 10% to about 30% or from about 12% to about 25% or from about 14% to about 23%, or about 18% by weight of the solvent cement. In the specification and appended claims, the range and ratio limits may be combined.

Volatile Organic Solvent

The volatile organic liquid or liquid mixture used as a solvent may be any liquid or liquids which will dissolve the water-insoluble polymers contained in the adhesive compositions.

In one embodiment, the compositions are to be used as adhesives such as solvent cements, and the solvent which also is a solvent for the plastic surface or surfaces which are to be joined or bonded together by the adhesive compositions. In addition, the organic liquids must be volatile, that is, the solvent(s) must be capable of vaporizing under a wide variety of application temperature conditions. In one embodiment, a volatile solvent is one which is capable of vaporizing at ambient or at temperatures slightly above ambient temperatures. The solvents should also be selected after consideration of the toxicity effects and biodegradability of the solvents.

The compositions of the present invention contain from about 30%, or from about 40%, or from a major amount of at least one volatile organic liquid. In one embodiment, the compositions of the present invention contain from about 65% up to about 85%, or from about 70% to about 80% or from about 73% to about 78% or about 75% by weight of at least one volatile organic solvent which is a solvent for CPVC. In one embodiment, the composition contains about 80% by weight of the at least one volatile organic solvent. In another embodiment, one volatile organic solvent is present in an amount from about 30% to about 90%, or from about 40% to about 80%, or from about 45% to about 70% by weight of the solvent cements.

The solvent cements disclosed herein contain an organic solvent which is capable of dissolving the resin in the concentration being used as well as dissolving the surfaces of articles being joined. That is to say, the solvent should also be capable of dissolving at least a portion of the outermost surface layer of the plastic articles to be bonded.

Although not wishing to be bound to any theory, it is believed that the solvent cements disclosed herein achieve adhesive bonding through an intermingling on a molecular level of the resin of the cement with the polymer forming the article to be bonded. Therefore, the solvent of these cements should be capable of dissolving enough of the surfaces of these articles to enable such an intermingling to occur. There is no particular depth to which the solvent must penetrate for this purpose, since it is a surface phenomenon.

Organic solvents of particular interest include tetrahydrofuran (THF), acetone (ACE), methyl ethyl ketone (MEK) and other low boiling solvents having boiling points less than 80° C. A more comprehensive discussion of solvents useful in the disclosed embodiments is found in U.S. Pat. No. 7,592,385, the disclosure of which is hereby incorporated by reference as if fully recited herein.

Mixtures of different solvents can also be used, provided that the solvent system as a whole exhibits the same solvency attributes mentioned above. Mixtures of acetone and THF are particularly interesting, especially those in which the weight ratio of THF to ACE is 20:1-1:10, more typically about 15:1. In addition to these solvents, the cements disclosed herein can include any of the additional solvents that are typically used in solvent cements as described, for example, in the patents mentioned above. For example, they may include methyl-ethyl ketone or esters such as methyl acetate, ethyl acetate, ethyl formate, ethyl propionate, and t-butyl acetate; halogenated solvents such as methylene chloride, ethylene dichloride, trichloroethylene; dibasic esters. When these solvents are present, typically they may be present in amounts no more than about 50, 40, 30, 20 or even 10 wt %, based on the total weight of solvent cement. Amounts of about 0.1, 1, 2, 5,10, and 15 wt. %, based on the total weight of solvent cement, are contemplated.

In one embodiment, when the compositions of the invention are to be used as solvent cements having low VOC, the solvents include tetrahydrofuran, methyl ethyl ketone, acetone, and mixtures thereof. When the water-insoluble polymer is CPVC, THF or mixtures of THF with one or more of MEK and acetone are useful solvents. In one embodiment, when the polymer is CPVC, the solvent includes methyl ethyl ketone, acetone, tetrahydrofuran or mixtures of two or more thereof. In one embodiment, the polymer is CPVC and the solvent includes THF in an amount from 0 to about 80%, or from about 20% to about 75%, or from about 30% to 65%, or from about 30% to about 50% by weight of the solvent cement, ACE in an amount from 0 to about 50%, or from 1% to about 20%, or from about 2% to about 10% by weight of the solvent cement and MEK in an amount from about 0 to about 50%, or from 20% to about 40% by weight of the solvent cement. In one embodiment, the composition includes the solvent THF in an amount of about 40% by weight of the solvent cement, and MEK in an amount of about 20% by weight of the solvent cement. In one embodiment, THF is present alone or in combination with one of ACE or MEK. In this embodiment, THF is present in a major amount (greater than 50%), or in an amount greater than about 60%, or greater than about 65%, or greater than about 70% by weight. Either the ACE, MEK or their combination is present in amount to make up the balance of the solvent, for instance from about 0% to 50%, or from about 2% to about 20%, or from about 3% to about 10% by weight.

In an embodiment, the polymer resin is CPVC and the solvent is THF present in an amount from 0 to about 85% and ACE in an amount from about 0 to about 10 weight % and cyclohexanone is completely avoided. In an alternative embodiment, the use of acetone is avoided. In an embodiment CPVC is present in an amount from 5 to 25%, from 10 to 20% or from 15-19% by weight.

In certain embodiments, the solvent cement comprises CPVC in an amount of 18%; THF in an amount of 73%; and ACE in an amount of 5%, and the cement is cyclohexanone free.

### EXAMPLES

A cyclohexanone-free solvent cement (FORMULA 1) was prepared according to certain embodiments described herein, specifically FORMULA 1 comprises: 73% THF, 5% ACE, 17.4% CPVC resin, 2% thickener and 2.5% stabilizer (all percentages are w/w of cement). One method for assessing the strength of a solvent cement (and the joint formed therewith), particularly those which will be utilized in high temperature applications (i.e., above 100° F.), is to affix a series of identical pipe joints using the solvent cement in question, and test each joint at a different curing time, by directing heated, pressurized water through the joint. Table 1 shows the minimum curing times required for the various pipe diameter test assemblies using FORMULA 1, where the listed temperatures and pressures relate to the water introduced into the test pipe.

TABLE 1

| | 100 PSI | 150 PSI | 200 PSI | 250 PSI |
|---|---|---|---|---|
| Sch 80 CPVC | (7 Kg/sq · cm) | (10.5 Kg/sq · cm) | (14 Kg/sq · cm | 17 Kg/sq · cm |
| 100 F. (37.7 C.) | 2″--30 min | 2″--2 hrs | 2″--16 hrs | 2″--16 hrs |
| | 3″--2 hrs | 3″--8 hrs | 3″--24 hrs | 3″--48 hrs |
| | 4″--2 hrs | 4″--12 hrs | 4″--48 hrs | 4″--72 hrs |
| 140 F. (60 C.) | 2″--30 min | 2″--2 hrs | 2″--16 hrs | 2″--1 wk |
| | 3″--4 hrs | 3″--72 hr | 3″--2 wks | 3″--8 weeks |
| | 4″--6 hrs | 4″--1 week | 4″--17 days | 4″--8 weeks |

| | | | |
|---|---|---|---|
| 180 F. (82 C.) | 2″--96 hrs | 2″--1 wk | N/A |
| | 3″--1 wk | 3″--2 wks | |
| | 4″--2 wks | 4″--3 wks | |

Table 2 below shows comparison of cure times for 2″ diameter test assembly, made using three solvent cements which contain Cyclohexanone. The data for FORMULA 1 in Table 2 is repeated from the cyclohexanone-free cement presented above. All values are for the 2″ diameter pipe for ease of comparison. The three CYH-containing formulas have the following approximate compositions:

FORMULA 2: THF: 36%; CYH: 12%; MEK: 22%; ACE 10%; CPVC resin 16%; additives˜4%.

FORMULA 3: THF: 60%; CYH: 8%; MEK: 0%; ACE: 9%; CPVC resin 20%; additives˜3%.

FORMULA 4: THF: 70%; CYH: 10%; MEK: 0%; ACE: 0%; CPVC resin 16%; additives˜3%.

TABLE 2

| Cement | Temperature 100 F. | | | | Temperature 140 F. | | | |
|---|---|---|---|---|---|---|---|---|
| formula | 100 psi | 150 psi | 200 psi | 250 psi | 100 psi | 150 psi | 200 psi | 250 psi |
| 1 | 30 min | 2 hrs | 16 hrs | 16 hrs | 30 mins | 2 hrs | 16 hrs | 1 wk |
| 2 | 30 min | 3 hrs | | >16 hrs | 2 hrs | 4 hrs | 48 hrs | >1 wk |
| 3 | 30 min | | | >16 hrs | | | | 2 wks |
| 4 | | | >16 hrs | | | | | |

It is clear from Table 2 that the cure times for effective bonding increase with increased testing pressure. There is little difference between the curing times required for each formula at the 100° F./100 psi scenario. However, the differences begin to emerge once pressures higher than 100 psi are required, with formula 2 requiring 50% more cure time at 150 psi.

The data is more pronounced for the 140 F tests. Formula 1 requires ¼ the cure time of formula 2 for the 100 psi; ½ the cure time for the 150 psi test as well as significantly lower cure times for the remainder of the tests. While all of the formulas required longer cure times than formula 1 excepting the 100° F./100 psi test cases, of particular note is the difference between formula 1 and formula 3 at 140° F./250 psi, where formula 3 required an additional week for an effective cure.

Overall, the CYH-free formulation disclosed herein (FORMULA 1) overcame the conventionally-perceived drawbacks expected of CYH-free solvent cements. The CYH-free formulation, FORMULA 1, achieved high bonding strength as the joints were able to withstand all of the tested pressures and temperatures. Unexpectedly, FORMULA 1 was able to achieve these high joint strengths in shortened cure times.

If desired, additional additives may be advantageously included in the compositions. Additives can include lubricants, stabilizers, plasticizers, colorants, pigments, thixotropic agents, polymeric rheology additives and processing aids, etc. Small amounts of pigments or colorants such as titanium dioxide, carbon black or a dye or other colorant may be added to the adhesive compositions to serve as a guide for uniform mixing and to provide a method of identifying various adhesive compositions.

Exemplary stabilizing agents for CPVC formulations include alkyltin compounds such as methyltin, butyltin and octyltin; dialkyltin dicarboxylates; methyltin mercaptides and butyltin mercaptides; dialkyltin bis(alkylmercaptocarboxylate) including di-n-octyltin-S, S′-bis(isooctylmercaptoacetate); butylthiostaunoic acid; etc. alkyltin stabilizers such as C4 to C6 alkyltin mercaptides are normally preferred. The stabilizers are generally present in amounts of from about 0.05 to 3% by weight. Triphenyl phosphite, BHT (butylated hydroxy toluene), complex calcium and zinc soaps of alkyl carboxylic acids and hydrotalcite can also be used.

The compositions of this disclosure are easy to apply, cost effective, and cure within a reasonable period of time without the use of heat, pressure, UV light or extraordinary mechanical devices. The bonding or adhesive properties are satisfactory for the intended uses whether non pressure drain, waste, vent (DWV), applications or pressure systems used in potable water applications.

The terms “a” and “an” and “the” and similar references used in the context of describing the disclosed embodiments (especially in the context of the following claims) are to be construed to cover both the singular and the plural, unless otherwise indicated herein or clearly contradicted by context.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the disclosed embodiments and does not pose a limitation on the scope of the disclosed embodiments unless otherwise claimed. No language in the specification should be construed as indicating any non-claimed element essential to the practice of the disclosed embodiments or any variants thereof.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability

Preferred embodiments of this invention are described herein, including the best mode known to the inventors for carrying out the invention(s). Of course, variations on the disclosed embodiments will become apparent to those of ordinary skill in the art upon reading the foregoing description. The inventors expect skilled artisans to employ such variations as appropriate, and the inventors intend for the invention(s) to be practiced otherwise than specifically described herein. Accordingly, this disclosure includes all modifications and equivalents of the subject matter recited in the claims appended hereto as permitted by applicable law. Moreover, any combination of the above described elements in all possible variations thereof is encompassed by the disclosed embodiments unless otherwise indicated herein or otherwise clearly contradicted by context.

Having shown and described an embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A solvent cement for bonding CPVC pipe and other molded articles, comprising:
a first solvent selected from the group consisting of THF, MEK, ACE in an amount from 0 to 80% by weight;
a second solvent selected from the group consisting of THF, MEK and ACE in an amount from 0 to 10% by weight;
at least one chlorinated thermoplastic resin in an amount of between 12 and 22% by weight, dissolved in the solvent; and
wherein the solvent cement is substantially free of cyclohexanone.

2. The cement of claim 1 wherein:
the first solvent is THF and is present in amount of 65 to 80% by weight;
the second solvent is ACE and is present in an amount of 0 to 6% by weight; and
the thermoplastic resin is CPVC present in an amount of 15-20%.

3. The cement of claim 2, comprising THF in an amount of 70 to 75% by weight.

4. The cement of claim 2 comprising ACE in an amount of 5% by weight.

5. The cement of claim 2 wherein the thermoplastic resin is CPVC.

6. The cement of claim 5, wherein the CPVC is present in an amount of 17-18% by weight.

7. The cement of claim 2, further comprising stabilizers and thickeners.

8. The cement of claim 2, wherein CPVC is present in an amount of 18%; THF is present in an amount of 73%; and ACE is present in an amount of 5%.

9. A method for bonding two CPVC articles, comprising:
applying a solvent cement composition to a surface to be bonded on a first CPVC article, the composition comprising a first volatile organic solvent in an amount from 0 to 80% by weight, a second volatile organic solvent in an amount from 0 to 10% by weight, CPVC in an amount from 12-22%, and wherein the composition is substantially free of cyclohexanone; and
bringing the surface to be bonded into contact with a second CPVC article.

10. The method of claim 9, wherein the first volatile organic solvent is THF, and the second volatile organic solvent is ACE.

11. The method of claim 9, wherein the first volatile organic solvent is THF and is present in an amount of 65-80%.

12. The method of claim 11, wherein the cement comprises THF in an amount of 70 to 75% by weight.

13. The method of claim 9, wherein the second volatile organic solvent of the cement is ACE and is present in an amount of 0 to 6%.

14. The method of claim 13, wherein the cement comprises ACE in an amount of 5% by weight.

15. The method of claim 9, wherein the CPVC is present in an amount of 16-22%.

16. The method of claim 9, wherein the THF is present in an amount of 72-75%.

17. The method of claim 9, wherein CPVC is present in an amount of 18%; THF is present in an amount of 73%; and ACE is present in an amount of 5%.
